(19) United States
(12) Patent Application Publication
(10) Pub. No.: US 2004/0125350 A1
(43) Pub. Date: Jul. 1, 2004

(54) Film frame alignment method and system for an imaging apparatus

(75) Inventors: Brian J. Kwarta, Pittsford, NY (US); Steve J. Pasquarette, Honeoye Falls, NY (US); Cynthia L. Vandewall, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/335,419

(22) Filed: Dec. 31, 2002

(51) Int. Cl. G03B 27/52

(52) U.S. Cl. 355/41

(57) ABSTRACT

The present invention provides for an imaging apparatus and a method of positioning an exposed image frame on photographic film at a predetermined position for scanning in the imaging apparatus. The apparatus of the present invention includes a preview device and a frame line detection user interface which appears on the preview device when an exposed image frame on the photographic film is offset from a predetermined position for scanning. A visible frame line indicator appears on the screen when the exposed image frames on the film is offset and is adapted to be moved to the leading or trailing edge of the exposed image frames. This permits a user to automatically align an offset exposed image frame with respect to a predetermined position for scanning while viewing the offset exposed image frame on the preview device.

### FIELD OF THE INVENTION

The present invention relates to a film frame alignment method and system for an imaging apparatus which involves the use of a frame line detection user interface. More specifically, the present invention relates to a method of positioning an exposed image frame on photographic film at a selected position for scanning in a scanning apparatus, as well as an imaging apparatus which includes a frame line detection user interface.

### BACKGROUND OF THE INVENTION

In conventional imaging apparatuses such as scanners which include optical systems, it is beneficial to use the optical system to preview an image captured on the photographic film on a preview device prior to scanning. In moving the photographic film along a film gate to a position for scanning, an operator has to be sure that the image frame is at a correct position for scanning. Conventional systems require that an operator manually advance the film forward or backward when a frame is misaligned by continuously depressing a forward/reverse button while viewing the misaligned frame, to bring the misaligned frame to a desired position for scanning. This is burdensome for an operator especially in a high volume operation.

FIG. 1 illustrates a conventional arrangement in which a film strip 100 is driven in direction 102 for exposure in an imaging apparatus. Film 100 includes film frame 104 or camera exposure “A” and film frame 106 or camera exposure “B”. The imaging apparatus includes a 45° beam splitter mirror 106a and an imaging lens 106b. Imaging lens 106b exposes images on film strip 100 onto paper 108 for exposure. During the above process, images on film strip 100 can be directed by beam splitter 106a through a viewing lens 106c for viewing by an operator at a viewer 111. A correct position for exposure is illustrated in FIG. 1 by reference numeral 110. When camera exposure 104 and camera exposure 106 are offset from correct position for exposure 110 as shown, the offset can be viewed on viewer 111 . In order to correct the offset frames, a user has to continuously click or depress a forward/reverse button 114 until either frames 104 or 106 are at position 110. As noted above, this is burdensome during a high volume operation.

Further, in the example of FIG. 1, the imaging apparatus is a scanner which is used in an optical lab that is adapted to preview an image and move the film while viewing the image (i.e. directly viewing the negative). Once the image frame is aligned RGB light beams are flashed to expose paper 108. The scanner of FIG. 1 does not provide for a visual frame line and is not adapted to automatically position the offset frame at a correct position for scanning. Also, the image viewed on viewer 111 is analogous to viewing a film strip in daylight and, thus, appears as a negative image for negative film. This is difficult to view, especially for an inexperienced operator.

U.S. Pat. No. 4,918,484 discloses a system for aligning a photographic film to be printed. However, this system utilizes a fine adjustment key on a keyboard and requires repetitive operation on the part of an operator to align an image. This patent does not disclose a method of positioning a frame line at an end of an offset image and thereafter placing the offset image at a correct position for scanning.

U.S. Pat. No. 4,963,919 discloses a system for assimilating the layout of a composed image by utilizing multiple frame lines. In the system of U.S. Pat. No. 4,963,919, there is no provision for positioning the frame line with respect to an offset image and placing the offset image at a correct position for scanning.

What is needed is a method that requires minimal operator input which facilitates the alignment of an offset image on a photographic film at a predetermined position for scanning.

### SUMMARY OF THE INVENTION

The present invention provides for a method and system of positioning an exposed image frame on a photographic film at a selected imaging position in an imaging apparatus. More specifically, the present invention relates to a method and system for positioning an exposed image frame on a photographic film at a selected position for scanning in a scanning apparatus.

In the method and system of the present invention, an optical system and a CCD area array imager of the imaging apparatus are utilized to preview images on a photographic film. With the system and method of the present invention, operators can advance film through the imaging apparatus while looking through a viewer of the preview device in order to align/define a leading edge of a frame.

The system and method of the present invention provides for a virtual frame line indicator to be displayed as an overlay to the preview image on a frame line detection interface. With the system and method of the present invention, operators are able to move the virtual frame line indicator in at least one of two ways. First, an operator may drag the frame line indicator or a visual indicator below a line or mark to align the indicator with either the leading or trailing edge of an image. Secondly, the operator may use a left/right arrow button to move the frame line indicator left or right across the preview window in a manner analogous to a horizontal movement of a scroll bar. Since movement of the frame line indicator of the present invention does not require film movement, the screen behavior is continuous and provides a similar user experience as an optical system.

Accordingly, the present invention provides for a method of positioning an exposed image frame of photographic film at a predetermined position for scanning in a scanning apparatus which comprises the steps of conveying a photographic film having exposed image frames thereon through a scanning apparatus; displaying the exposed image frames on a preview device; displaying a frame line detection user interface on the preview device when it is detected that an exposed image frame on the photographic film is offset from the predetermined position for scanning, with the frame line detection user interface comprising at least an interface display, the offset exposed image frame and a visible frame line indicator. The visible frame line indicator is adapted to move from any position on the interface display to an aligned position on the interface display which represents that an exposed image frame is positioned at the predetermined position for scanning. The method of the present invention further requires the steps of moving the visible frame line indicator to either a leading edge or a trailing edge of the displayed offset exposed image frame; and automatically moving the visible frame line indicator and the displayed offset exposed frame directly to the aligned position on the interface display which represents the predetermined position for scanning. The photographic film and the offset exposed image frame on the film are moved a corresponding amount in the scanning apparatus based on the amount of movement of the visible frame line indicator on the interface display to place the offset exposed image frame on the photographic film at the predetermined position for scanning.

The present invention further relates to an imaging apparatus that comprises a preview device for previewing exposed image frames on photographic film which are to be scanned; and a frame line detection user interface which appears on the preview device when an exposed image frame on the photographic film is offset from a predetermined position for scanning. The frame line detection user interface comprises an interface display which displays the offset exposed image frame and a visible frame line indicator. The visible frame line indicator is adapted to move from any position on the interface display to an aligned position on the display which represents that an exposed image frame on a photographic film is positioned at the predetermined position for scanning.

### BRIEF DESCRIPTION OF THE DRAWINGS

FIG. 1 is a schematic view of a related imaging apparatus;

FIG. 2 is a schematic view of an imaging apparatus in accordance with the present invention;

FIG. 3 is a representation of a portion of a film having exposed image frames thereon, as well as an imaging lens and a CCD array in accordance with the present invention; and

FIG. 4 is a schematic view of a preview device and frame line detection user interface in accordance with the present invention.

### DETAILED DESCRIPTION OF THE INVENTION

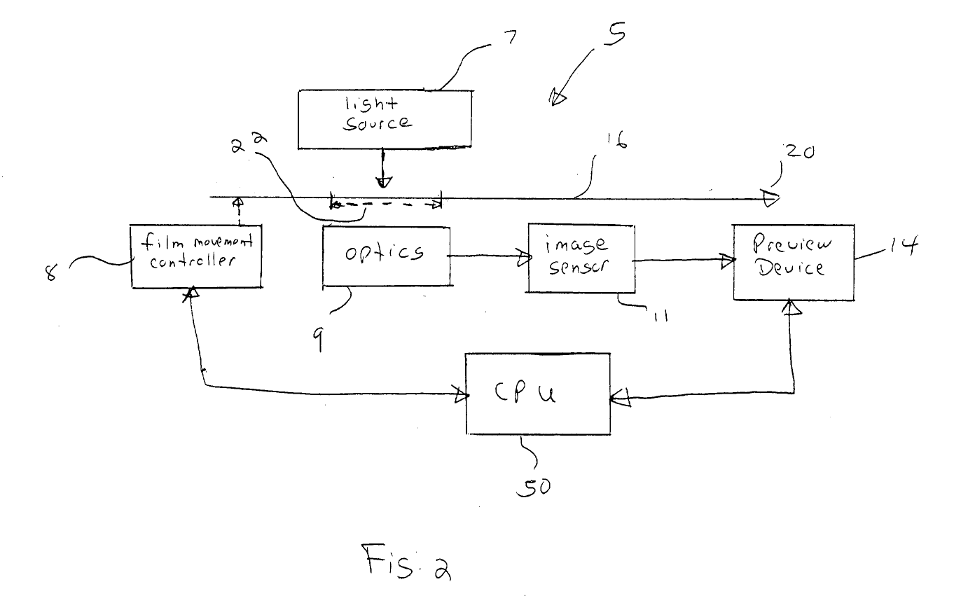

Referring now to the drawings, wherein like reference numerals represent identical or corresponding parts throughout the several views, an imaging apparatus 5 is schematically represented in FIG. 2. In general, imaging apparatus 5 can be a scanner which includes a light source 7 which directs light onto film 16 in a film path. The light which passes through the film is focused by way of optics 9 such as an imaging lens onto an image sensor 11, and image data representative of the exposed image frame on film 16 is subsequently processed for scanning or storage purposes. Image sensor 11 is preferably a CCD area array imager. Imaging apparatus 5 further includes a preview device 14 which comprises a screen to enable a user to preview the exposed image frame on film 16 at a predetermined scanning position as the film is moved past the scanning position. More specifically, and as known in scanners, a film gate is usually positioned relative to light source 7 to define a predetermined scanning position, such that when an exposed film is properly positioned at the film gate, subsequent scanning can occur.

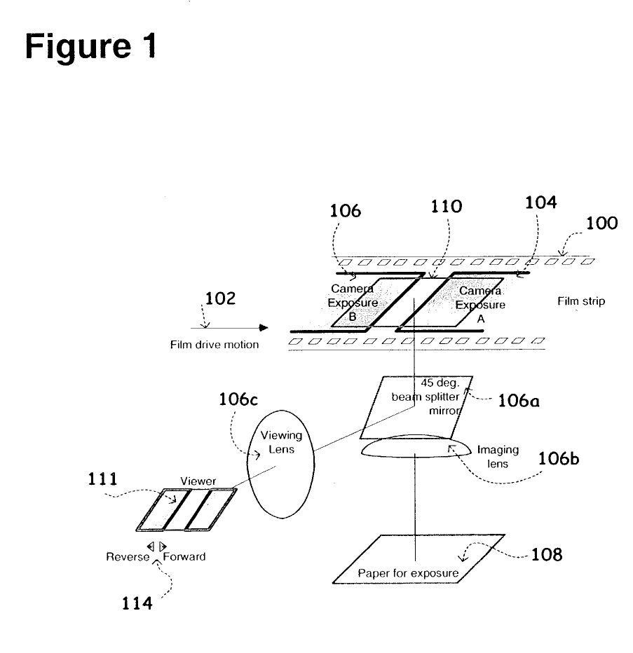

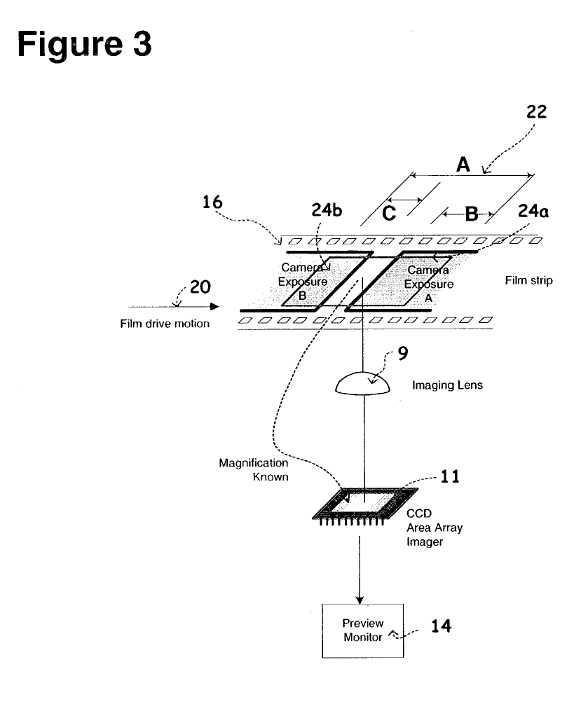

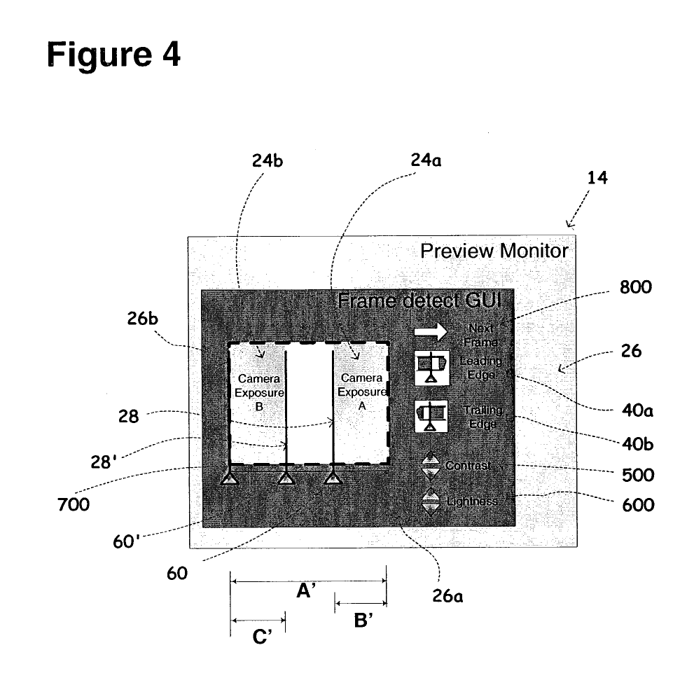

Imaging apparatus 5 is preferably part of a digital minilab. In imaging apparatus 5, the film is preferably moved in frame steps, however, unlike the arrangement of FIG. 1, in imaging apparatus 5 there is no direct viewing of a negative. In the arrangement of FIG. 2 as well as FIGS. 3-4, the negative is viewed after a low resolution image capture from image sensor 11. This image is accordingly viewed on preview device 14.

Therefore, as an example, film 16 is conveyed in direction 20 past light source 7 to a predetermined scanning position or station represented by reference numeral 22. At predetermined scanning position or station 22, light from light source 7 passes through film 16 and is focused by way of optics 9 onto an image sensor 11 such as a CCD. The position of the exposed image frame on film 16 at scanning position or station 22, can be viewed by way of preview device 14 by an operator.

FIG. 3 illustrates film 16 relative to image sensor 11 and optics 9. In the example of FIG. 3, a first exposed image frame 24a (Camera Exposure A) and a second exposed image frame 24b (Camera Exposure B) are shown. For scanning purposes, each of the image frames 24a, 24b, etc. of the photographic film has to be properly positioned at scanning position or station 22 which has a length “A”. On some occasions, the exposed image frames 24a, 24b are not properly aligned with respect to scanning position or station 22.

The present invention provides for preview device 14 (FIGS. 3 and 4) which includes a screen, display or monitor 26. With the arrangement of the present invention, when the position of exposed image frames 24a, 24b are offset from predetermined scanning position 22, a frame line detection user interface 26a is visually displayed on preview device 14 as shown in FIG. 4. With preview device 14 and CCD area array imager 11, the images are shown in the real colors of the original scene, and not the inverted colors of the negative film as discussed with reference to FIG. 1.

In FIG. 3, length A equals the width of predetermined position for scanning 22; reference letter B represents a distance between one end of predetermined position for scanning 22 and a trailing edge of exposure 24a; and reference letter C represents a distance from the other end of predetermined position for scanning 22 and the leading edge of exposure 24b.

Therefore, frame line detection user interface 26a is displayed on preview device 14 when it is detected that an exposed image frame 24a or 24b on photographic film 16 is offset from predetermined position 22 for scanning. As shown in FIG. 4, frame line detection user interface 26a includes an interface display 26b which has a width A′. Interface display 26b displays at least one offset exposed image frame 24a, 24b and a visible frame line indicator 28.

Reference letter B′ of FIG. 4 represents a line indicator position for frame line indicator 28 when indicator 28 is at the trailing edge of exposure 24a. Reference letter C′ represents a line indicator position for frame line indicator 28 when it is at the leading edge of exposure 24b (this is represented by reference number 28′ in FIG. 4). It is noted that reference numerals 28, 28′ represent two different positions for a single line indicator. Therefore, in order to determine the value of B in FIG. 3, the following equation

$$\frac{B}{A} = \frac{{B}^{′}}{{A}^{′}}$$

is solved for B. That is, since the value for A (i.e. the width of the frame which represent the correct position for scanning 22), the value for A′ (the width of interface display 26b), and the value for B′ (the distance between an end of display 26b and indicator 28) are known, it is possible to solve for B. This essentially defines a calibration feature for indicator 28.

As an option, visible frame line indicator 28 can be calibrated by way of a calibration line which also optically may appear on display 26a, such that frame line indicator 28 can be moved from any position on display 26b to an aligned position on display 26b that represents that an exposed image frame is positioned at predetermined position for scanning 22 . The above described movements to the aligned position is possible due to the fact that the magnification between the film track and image sensor 11, and the width A′ of display 26b are known. Therefore, any screen pixel step of indicator line 28 within display 26b is a percent of the image size in the scanner. This is a 1:1 correlation. For example, if display 26b is 100 pixels wide and indicator line 28 is moved 60 pixels from its home position 700, this would correspond to a 60% motion of the film frame. If the film frame is 36 mm wide, it would be necessary to move the film back 21.6 mm since the magnification as noted above is known.

In the example of FIG. 4, it is seen that exposed image frames 24a and 24b are offset from predetermined position for scanning 22. When it is detected, either automatically or by a user, that the exposed image frames are offset on display 26b, a user can grab and drag frame line indicator 28 to a position where it is aligned with either the trailing edge of exposed image frame 24a or the leading edge of exposed image frame 24b (assuming film movement in direction 20). In one example of FIG. 4, frame line indicator 28 is dragged so as to be positioned at the trailing edge of exposed image frame 24a as illustrated. At that point and in view of the fact that frame line indicator 28 is calibrated on screen 26b in the manner as described, it is known how far frame line indicator 28 has traveled so as to be aligned with the trailing edge of exposed image frame 24a and thereby, it is known how far to move the film in order to align exposed image frame 24a at predetermined position for scanning 22 within display 26b (i.e. frame line indicator 28 should move a distance A′−B′ to cause a reverse movement of film 16a distance A−B). To do this, after the user has dragged line 28 to the trading edge of exposed image frame 24a, a user can simply press an accept button 40b as shown in FIG. 4 which can be a touch-screen member.

In the example of FIG. 4, a button 40a (which can also be a touch-screen member) would be pressed if indicator line 28 were placed at a leading edge of frame 24b (this is shown in FIG. 4 as indicator line 28′), so that, for example, exposed image frame 24b would be automatically advanced to line up at predetermined position for scanning 22.

For example, when indicator line 28′ is at the leading edge of exposure 24b, pressing button 40a would automatically move exposure 24b forward by a distance A′−C′, and therefore, move the film a distance A−C. As a further example with regard to advancing the film, if display 26b is 100 pixels wide (A′), and indicator line 28′ is moved 35 pixels from home position 700 (C′); this would correspond to a 65% motion (A′−C′) of the film frame. If the film frame is 36 mm wide, it would be necessary to move the film forward 23.4 mm (0.65×36).

At the same time, imaging apparatus 5 includes a film movement controller 18 which could be gears, conveyor belts, etc., that would receive a signal from a controller or CPU 50 (FIG. 2) indicative of how far film 16 needs to be moved to align exposed image frame 24a or 24b at the film gate or more specifically, at predetermined position for scanning 22. In view of this, film 16 is moved an appropriate amount based on the movement that has occurred on display 26b, so as to align exposed image frame 24a or 24b at predetermined position for scanning 22 with respect to light source 7.

Therefore, in the present invention, virtual frame line indicator 28 can be displayed as an overlay to the preview image on display 26b. Operators are then able to move virtual frame line indicator 28 in one of two ways. First, an operator can drag frame line indicator 28 to align indicator 28 with either the leading or trailing edge of an exposed image frame. As another option, an operator may use left/right arrow buttons to move frame line indicator 28 to the left or right across the preview window in a manner analogous to a horizontal scroll bar's movement. Since movement of frame line indicator 28 does not require film movement, the screen behavior is continuous and provides a similar user experience as an optical system. However, with the system of the present invention, the user views an improved image in real colors.

In a further feature of the invention as shown in FIG. 4, the image content of the preview image can be enhanced by providing a contrast adjustment button 500 and a lightness adjustment button 600 on interface 26a which can be touch-screen members. Therefore, by improving the content of the images on display 26b by adjusting contrast and lightness through buttons 500, 600 the process of aligning an image frame for scanning is facilitated.

With the use of the frame line indicator of the present invention, an operator is not required to continuously press buttons to align an image to a scanning position. The present invention enables the automatic appearance of the frame line indicator interface 26a in a pop-up dialog manner upon the detection that the exposed image frames are offset with respect to a predetermined position for scanning. When the frame line indicator has been moved to the desired position with respect to the leading or trailing edge of the offset exposed image frame, an operator simply has to depress an accept button to automatically move the offset exposed image frame to the correct position for scanning.

In a preferred feature of the invention as shown in FIG. 4, the frame line indicator can include a slider widget 60 or 60′ aligned with frame line indicator 28 or 28′ to assist an operator in moving frame line indicator 28 or 28′ and aligning the offset exposed image frame. As a still further option, widget 60 or 60′ can be a touch screen member and can be moved relative to frame line indicator 28 or 28′ such that movement of widget 60 or 60′ so as to be aligned with the frame line indicator achieves the function of grabbing frame line indicator 28 or 28′ and moving frame line indicator 28 or 28′ to the desired position. After the frame line indicator has been moved to the desired position and an accept operation by way of buttons 40a and 40b has been initiated to automatically move the offset exposed image frame to the desired position for scanning, film motor movement controller 18 can be automatically operated to move film 16 along the film path to the appropriate position in correspondence with the amount of movement on display 26b. As also shown in FIG. 4, a next frame button 800 (which can also be a touch screen member) can be used to move the film a full frame amount. This is useful at the beginning of film with long leaders.

The invention has been described in detail with particular reference to certain preferred embodiments thereof, but it will be understood that variations and modifications can be effected within the spirit and scope of the invention.

What is claimed is:

1. A method of positioning an exposed image frame on photographic film at a predetermined position for scanning in a scanning apparatus, the method comprising the steps of:
conveying a photographic film having exposed image frames thereon through a scanning apparatus;
displaying the exposed image frames on a preview device;
displaying a frame line detection user interface image on the preview device when it is detected that an exposed image frame on said photographic film is offset from the predetermined position for scanning, said frame line detection user interface image comprising at least an interface display, the offset exposed image frame and a visible frame line indicator, said visible frame line indicator being adapted to move from any position on the interface display to an aligned position on the interface display which represents that an exposed image frame is positioned at the predetermined position for scanning;
moving the visible frame line indicator to a leading edge or a trailing edge of the displayed offset exposed image frame; and
automatically moving the visible frame line indicator and the displayed offset exposed image frame directly to the aligned position on the interface display which represents the predetermined position for scanning.

2. A method according to claim 1, further comprising moving said photographic film and said offset exposed image frame on said film a corresponding amount in said scanning apparatus based on the amount of movement of the visible frame line indicator on the interface display to place said offset exposed image frame on said photographic film at the predetermined position for scanning.

3. A method according to claim 1, wherein said visible frame line indicator is displayed as an overlay to the exposed image frame on the interface display.

4. A method according to claim 1, comprising the further step of adjusting at least one of a contrast or lightness of the images on said interface display.

5. An imaging apparatus comprising:
a preview device for previewing exposed image frames on photographic film which are to be scanned; and
a frame line detection user interface which appears on the preview device when an exposed image frame on the photographic film is offset from a predetermined position for scanning, said frame line detection user interface comprising an interface display which displays the offset exposed image frame and a visible frame line indicator, said visible frame line indicator being adapted to move from any position on the interface display to an aligned position on the interface display which represents that an exposed image frame on said photographic film is positioned at the predetermined position for scanning.

6. An imaging apparatus according to claim 5, wherein said frame line detection user interface further comprises:
at least one accept button member which is adapted to move the visible frame line indicator and the displayed offset exposed image frame to the aligned position on the interface display which represents the predetermined position for scanning.

7. An imaging apparatus according to claim 6, wherein said at least one accept button member is a touch screen member.

8. An imaging apparatus according to claim 5, wherein said user interface further comprises a contrast adjustment button for adjusting a contrast of the exposed image and a lightness adjustment button for adjusting a lightness of the exposed image.
